(19) United States
(12) Patent Application Publication
(10) Pub. No.: US 2009/0193863 A1
(43) Pub. Date: Aug. 6, 2009

(54) Process for Removing and Recovering Phosphorus from Animal Waste

(75) Inventors: Ariel A. Szogi, Florence, SC (US); Matias B. Vanotti, Florence, SC (US); Patrick G. Hunt, Florence, SC (US)

Correspondence Address: USDA, ARS, OTT, 5601 SUNNYSIDE AVE, RM 4-1159, BELTSVILLE, MD, 20705-5131, US

(73) Assignee: The United States of America, as represented by the Secretary of Agriculture

(21) Appl. No.: 12/026,346

(22) Filed: Feb. 5, 2008

(51) Int. Cl. C05F 3/00; C07F 9/02

(52) U.S. Cl. 71/21; 568/8

(57) ABSTRACT

A process for extraction and recovery of phosphorus from solid animal wastes such as for example, poultry litter waste, includes the steps of phosphorus extraction, phosphorus recovery, and phosphorus recovery enhancement. The process can be performed in batch or continuous mode.

### FIELD OF THE INVENTION

The invention relates to a process for extracting and recovering phosphorus from animal wastes.

### BACKGROUND OF THE INVENTION

Animal production, a major component of the United States of America agricultural economy, is at risk because of both real and perceived environmental problems. Dramatic advancements are required to protect the environment, save this vital industry, and maintain food security. Municipal and agricultural waste disposal is a major problem. For agricultural animals, the animals are confined in high densities and lack functional and sustainable treatment systems. Confined livestock produce approximately 1329 million pounds of recoverable manure phosphorus annually with about 70% (approximately 925 million pounds) in excess of on-farm needs. This livestock production system was developed in the early and mid 20^{th} century prior to the current trend in high concentrated livestock operations. One of the main problems in sustainability is the imbalance of nitrogen (N) and phosphorus (P) applied to land (USEPA, supra; Edwards and Daniel, Environmental Impacts of On-Farm Poultry Waste Disposal—A Review, Bioresouree Technology, Volume 41, 9-33, 1992). Nutrients in manure are not present in the same proportion needed by crops, and when manure is applied based on a crop's nitrogen requirement, excessive phosphorus is applied resulting in phosphorus accumulation in soil, phosphorus runoff, and eutrophication of surface waters (Sharpley et al. Overcoming the challenges of phosphorus-based management in poultry, farming, J. Soil Water Conserv. Volume 62, 375-389, 2007; Heathwaite et al., A conceptual approach for integrating phosphorus and nitrogen management at watershed scales, J. Environ. Qual., Volume 29, 158-166, 2000; Sharpley et al., Practical and innovative measures for the control of agricultural phosphorus losses to water: An overview, J. Environ, Qual., Volume 29, 1-9, 2000; Edwards and Daniel, Environmental Impacts of On-Farm Poultry Waste Disposal—A Review, Bioresource Technology, Volume 41, 9-33, 1992).

Phosphorus build up in soils to excessively high levels due to animal manures often results in eutrophication and pollution of surface waters due to intense application of animal manures to land (Edwards and Daniel, 1992; USEPA, 1992; Heathwaite et al., 2000; Sharpley et al., 2000). Thus is a “national problem affecting dairy, poultry, and swine production systems. Consequently, a substantial amount of manure phosphorus needs to be moved at least off the farms and some needs to be transported longer distances beyond county limits to solve accumulation and distribution problems of this nutrient (USDA-ERS, 2000). Manure nutrients in excess of the assimilative capacity of land available on farms are an environmental concern often associated with confined livestock production. The ability to extract phosphorus from manure will be critical to poultry and livestock producers to accomplish manure utilization through land application without elevating soil phosphorus levels when land is limiting. In addition, the aspect of phosphorus reuse is becoming important for the fertilizer industry because the world phosphorus reserves are limited (Smil, 2000). According to the Potash and Phosphate Institute, the United States annual consumption of inorganic phosphorus for crop production is about 3700 million pounds (Potash and Phosphate Institute, 2002). On the other hand, for the United States as a whole, confined livestock produces about 1,329 million pounds of recoverable manure phosphorus annually with about 70% (about 925 million pounds) in excess of on-farm needs (Kellog et al., 2000). Therefore, reuse of phosphorus recovered from animal waste could substitute about 25% of the phosphorus now obtained from mining.

Farmers obtain nutrients for their crops from inorganic commercial fertilizers and from organic sources such as animal manure and biosolids from wastewater treatment plants. Inorganic nitrogen and phosphorus compounds are water soluble and readily available to plants. Most organic nutrient sources contain both inorganic forms of nutrients and forms that must first be mineralized or decomposed to become available to plants. The movement of nitrogen and phosphorus through soil are different. If nitrogen is converted to the highly water soluble nitrate-nitrogen form, and it is not used during plant growth, it can move through the soil-water system and be vulnerable to leaching into groundwater. Soil amended with large quantities of organic or inorganic phosphorus may generate significant amounts of soluble phosphorus that can be readily transported by surface and subsurface runoff and groundwater leachate.

A further problem with the management of human and animal waste is the loss of nutrients. Phosphates, and nitrates are fundamental nutrients which determine the possibility for plant and animal life to occur. They are taken up by plants and the plants are eaten by animals. Subsequently they should return to the soil as manure in a normal agricultural cycle, but in the present situation in most cases they end up washed in the sea, whether they are simply dumped in a river or go through a municipal wastewater treatment

The lack of closure of the nutrient cycle is a major environmental problem, specially in the case of phosphates which, at present, are considered a mineral resource to be extracted. Excess of phosphates in the seas causes eutrophication. The depletion of the mineral phosphate resources is a problem which will become important in the near future (Scrivani et al. Solar trough concentration for fresh water production and waste water treatment, Desalination, Volume 206, 485-493, 2007)

In livestock operations, the crop acreage is typically calculated to allow for uptake by the crops of the applied nitrogen from the soil, thus minimizing movement of nitrogen in ground and surface water beyond the farm's boundaries.

Unlike carbon and nitrogen, phosphorus cannot volatilize from the system. Crops typically take up less phosphorus from the soil than that applied in the manure because the acreage has been calculated for nitrogen removal, which requires less acreage. The soil absorbs phosphorus, but over time reaches saturation. Additional application of phosphorus can cause release of phosphorus to surface waters beyond the farm's boundaries, risking oxygen depletion of water organisms. Measures for reducing phosphorus content of manure must be considered.

Phosphorus inputs accelerate eutrophication when it runs off into fresh water and has been identified as a major cause of impaired water quality (Sharpley et al., 2000, supra). Eutrophication restricts water use for fisheries, recreation, industry, and drinking due to the increased growth of undesirable algae and aquatic weeds and resulting oxygen shortages caused by their death arid decomposition. Also many drinking water supplies throughout the world experience periodic massive surface blooms of cyanobacteria. These blooms contribute to a wide, range of water-related problems including summer fish kills, unpalatability of drinking water, and formation of trihalomethane during water chlorination. Consumption of cyanobacteria blooms or water-soluble neuro- and hepatoxins released when these blooms die can kill livestock and may pose a serious health hazard to humans. Recent outbreaks of the dinoflagellate Pfiesteria piscicida in near-shore waters of the eastern United States also may be influenced by nutrient enrichment. Although the direct cause of these outbreaks is unclear, the scientific consensus is that excessive nutrient loading helps create an environment rich in microbial prey and organic matter that Pfiesteria and menhaden (target fish) use as a food supply. In the long-term, decreases in nutrient loading will reduce eutrophication and will likely lower the risk of toxic outbreaks of Pfiesteria-like dinoflagellates and other harmful algal blooms. These outbreaks and awareness of eutrophication have increased the need for solutions to phosphorus run-off.

Past research efforts on phosphorus removal from wastewater using chemical precipitation have been frustrating due to the large chemical demand and limited value of by-products such as alum sludge, or because of the large chemical demand and huge losses of ammonia at the high pH that is required to precipitate phosphorus with calcium (Ca) and magnesium (Mg) salts (Westerman and Bicudo, Tangential flow separation and chemical enhancement to recover swine manure solids and phosphorus, ASAE Paper No. 98-4114, St. Joseph, Mich.: ASAE, 1998); Loehr et al., Development and demonstration of nutrient removal from animal wastes, Environmental Protection Technology Series, Report EPA-R2-73-095, Washington, D.C.: EPA, 1973). Other methods used for phosphorus removal include flocculation and sedimentation of solids using polymer addition, ozonation, mixing, aeration, and filtration (See U.S. Pat. No. 6,193,889 to Teran et al). U.S. Pat. No. 6,153,094 to Craig et al. teaches the addition of calcium carbonate in the form of crushed limestone to form calcium phosphate mineral. The patent also teaches adsorbing phosphorus onto iron oxyhydroxides under acidic conditions.

Continuing efforts are being made to improve agricultural, animal, and municipal waste treatment methods and apparatus. U.S. Pat. No. 5,472,472 and U.S. Pat. No. 5,078,882 (Northrup) disclose a process for the transformation of animal waste wherein solids are precipitated in a solids reactor, the treated slurry is aerobically and anaerobically treated to form an active biomass. The aqueous slurry containing bioconverted phosphorus is passed into a polishing ecoreactor zone wherein at least a portion of the slurry is converted to a beneficial humus material. In operation the system requires numerous chemical feeds and a series of wetland cells comprising microorganisms, animals, and plants. See also U.S. Pat. Nos. 4,348,285 and 4,432,869 (Groeneweg et al); U.S. Pat. No. 5,627,069 to Powlen; U.S. Pat. No. 5,135,659 to Wartanessian; and U.S. Pat. No. 5,200,082 to Olsen et al (relating to pesticide residues); U.S. Pat. No. 5,470,476 to Taboga; and U.S. Pat. No. 5,545,560 to Chang.

One of the main problems in sustainability of poultry production is the imbalance between nitrogen and phosphorus in the waste (Edwards and Daniel, USEPA, 2001). Nutrients in manure are not present in the same proportion needed by crops. The mean N:P ratio in manure is generally lower than the mean N:P ratio taken up by major grain and hay crops (USDA, 2001). To solve the problem of a phosphorus buildup in soil and increased potential for phosphorus losses through runoff and subsequent eutrophication of surface waters, efforts are being made to immobilize phosphorus of find alternative uses for poultry litter such as burning and gasification and transport to agricultural lands with low levels of phosphorus. Current methods for handling phosphorus in waste include immobilization, see for example U.S. Pat. No. 6,923,917, issued Aug. 2, 2005;, gasification (Seth and Turner, 2002), precipitation, see U.S. Pat. No. 7,005,072; issued Feb. 8, 2006; litter transport to agricultural lands with low levels of phosphorus (Jones and D'Souza, 201; Kellerher et al., 2002; Keplinger and Hauck, 2004); anaerobic digestion by combustion (USDOE-NREL, 2000), etc.

While various systems have been developed for treating solid animal waste for the removal of phosphorus, there still remains a need in the art for a more effective treatment system for the phosphorus. The present invention, different from prior art systems, provides a system for extracting phosphorus from solid animal manure using a rapid extraction and subsequent recovery.

### SUMMARY OF THE INVENTION

It is therefore an object of the present invention to provide a process for removing phosphorus from solid animal manure using a three step quick wash process.

A still further object of the present invention is to provide a process for removing phosphorus from solid animal manure wherein the first step of the process is a phosphorus extraction step.

Another object of the present invention is to wash an animal solid waste with water and acid at a pH lower than about 5.

A still further object of the present invention is to use a rapid hydrolysis reaction as a part of the phosphorus extraction step in order to convert organically bound phosphorus to soluble phosphorus and to release phosphorus from insoluble inorganic phosphate complexes.

Another object of the present invention is to use mineral or organic acids for the rapid hydrolysis reaction in step one of the phosphorus removal process.

A still further object of the present invention is to dewater the washed litter residue in step one to prevent unnecessary carbon and nitrogen oxidation and digestion.

Another object of the present invention is to provide a process for removing phosphorus from solid animal manure wherein the second step of the process is a phosphorus recovery step.

A still further object of the present invention is to provider process for removing phosphorus from solid animal manure wherein the phosphorus recovery step includes the addition of an alkaline earth base to the liquid extract to precipitate phosphorus and form an alkaline earth metal-containing phosphorus product.

A still further object of the present invention is to provide a process for removing phosphorus from solid animal manure wherein the third step of the process is a phosphorus recovery enhancement step.

Another object of the present invention is to provide a process for removing phosphorus from solid animal manure wherein the third step of the process includes adding a flocculant to enhance the phosphorus grade of the product.

A still further object of the present invention is to provide a phosphorus fertilizer material made by the process of the present invention wherein the P₂O₅ is greater than about 10%.

Another object of the present invention is to provide a washed solid residue made by the process of the present invention which has a nitrogen:phosphorus ratio that is environmentally safe for land application and crop use.

A still further object of the present invention is to provide a washed solid litter residue produced by the process of the present invention that can be digested for methane production or utilized as an animal bedding.

Further objects and advantages of the present invention will be apparent from the following detailed description.

### BRIEF DESCRIPTION OF THE DRAWINGS

FIG. 1 is a schematic drawing of the step 1 of the quick wash process of poultry litter showing phosphorus extraction showing an extraction tank 20.

FIG. 2 is a schematic drawing of the quick wash process showing: [1] Phosphorus extraction in an extraction tank 20, [2] phosphorus recovery in a phosphorus removal tank 30, and [3] phosphorus enhancement in phosphorus removal tank 30.

FIG. 3 is a schematic drawing of the field prototype system for solid man quick wash showing a field prototype system for a solid manure quick wash process including an extraction tank 20, and a phosphorus removal tank 30.

FIG. 4 is a graph showing particle size distribution of homogenized broiler litter used in field prototype experiments. Each data point is the mean of three replicates.

FIG. 5 is a graph showing extraction of phosphorus from poultry lilter using acids at seven concentration levels.

FIG. 6 is a graph showing the pH on total phosphorus extracted from broiler litter. Total phosphorus concentration increased with decreasing pH of mineral and organic acids extracting solutions; more than about 50% of total phosphorus was extracted with respect to initial total phosphorus content in broiler litter at pH lower than 5 of the extracting acid solutions. The % phosphorus extracted from solids corresponds with values in FIG. 5. Variables in regression line y=−11x+107 are x=pH and y=% phosphorus extracted from solids.

FIG. 7 is a graph showing effect of stirring time on total phosphorus concentration in the extract. Broiler litter was extracted with citric acid solution at pH about 4.5 (step 1). Data show that total phosphorus concentration stays stable in supernatant liquid with stirring time between about 20 and 60 minutes. Data points are average concentrations of two separate runs using the field prototype.

### DETAILED DESCRIPTION OF THE INVENTION

Land application of large amounts of solid animal wastes is an environmental concern often associated with excess phosphorus in soils and potential pollution of water resources. Recovery of phosphorus from solid waste was developed for extraction and recovery of phosphorus from animal solid manures and poultry manure. The invention can use different types of poultry manure such as litter (manure mixed with bedding material), or cake (manure with minimal bedding material).

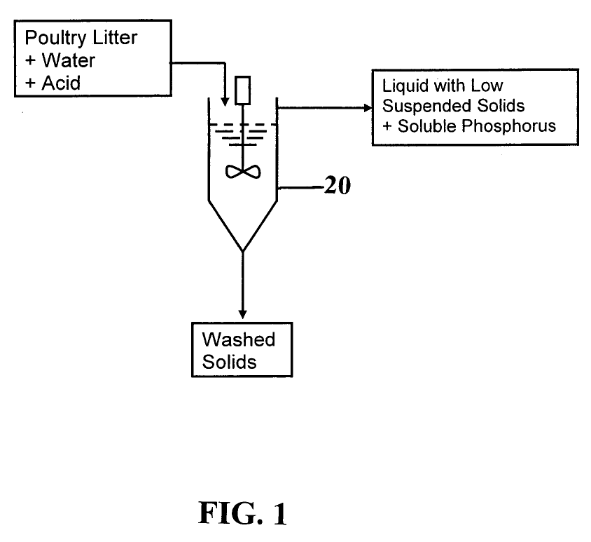

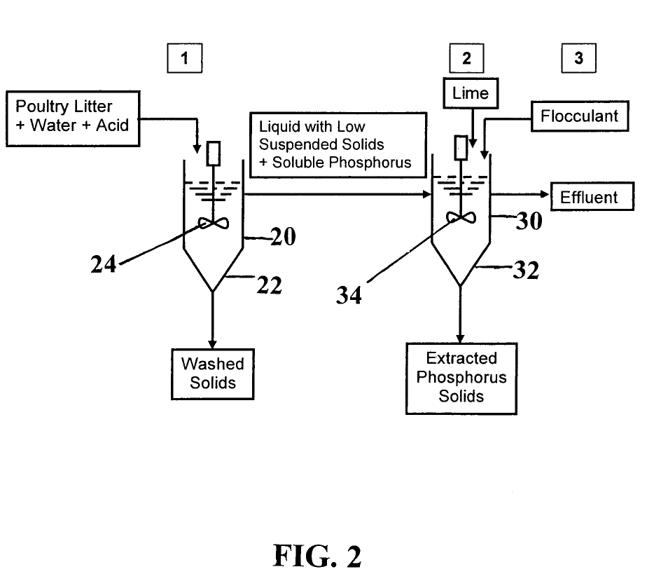

The method includes three consecutive steps: (1) phosphorus extraction, (2) phosphorus recovery, and (3) phosphorus recovery enhancement. In the first step, animal solid manures or poultry manure is washed by mixing it with water and acid in a reactor vessel at pH lower than about 5.0 (FIG. 1). The washed solid manure residue is settled and is dewatered to prevent unnecessary carbon and nitrogen oxidation and digestion. This first step produces a liquid extract containing low suspended solids of about 3 g/L and extracted soluble phosphorus. The washed washed solid manure residue is subsequently separated from the liquid extract and dewatered; unnecessary carbon and nitrogen oxidation and digestion are prevented by dewatering the residue. The liquid extract is transferred to a second vessel where phosphorus is recovered in steps 2 and 3 (FIG. 2). In step 1, organically bound phosphorus is first converted to soluble-P by rapid hydrolysis reactions using mineral or organic acids. This method hydrolyzes organic phosphorus-containing compounds rapidly in order to extract the phosphorus but not the nitrogen. This step also releases phosphorus from insoluble inorganic phosphate complexes. Therefore, for purposes of the present invention, rapid hydrolysis is defined as any hydrolysis reaction which allows extraction of phosphorus but not nitrogen. The hydrolysis and solubilization of phosphorus compounds are obtained by using organic acids such as citric, oxalic, malic, etc., mineral acids such as hydrochloric or sulfuric, for example, or a mixture of both mineral and organic acids or their precursors. The acids used in the process can be produced using different acid precursors that consist of organic substrate including animal waste transformed into acid compounds by bacterial, yeast, or fungal microorganisms for example such as Thiobacillus sp., Arthrobacter paraffineus, Candida sp., and Aspergillus niger. Furthermore, any mineral acid or organic acid can be used in the rapid hydrolysis step. Although the preferred acids for quick wash are those acids which do not add phosphorus or nitrogen, the used of acids such as nitric, ethyldiamintetracetic, sulfuric or phosphoric may be used during the process of the present invention to fortify the final extracted product with nitrogen, sulfur or phosphorus.

In step 2, phosphorus is precipitated by addition of an alkaline earth base such as for example lime (calcium hydroxide), magnesium hydroxide, calcium oxide, magnesium oxide, and mixtures thereof to the liquid extract to a pH range of about 9.0 to about 11.0 to form an alkaline earth metal-containing phosphorus compound.

In step 3, an organic flocculant is added into the second vessel to enhance precipitation and phosphorus grade of the precipitated product. After a settling period, of less than about 30. minutes the precipitated phosphorus-rich solid is removed from the bottom of the second vessel while the supernatant liquid is recycled back into the quick wash system or land applied. The flocculant is a poly-electrolyte and is added at less than about 10 ppm to increase the yield of filtering. One example of a filtering device is a 0.84 m×0.84 m×0.13 sieve box with a 0.6 wire mesh bottom and a commercial polypropylene non-woven fabric (Dupont E.I. de Nemours, N.J.). One of ordinary skill in the art could readily determine any other filter that would be useable in the process of the present specification. The nitrogen:phosphorus ratio (N:P) of the solids is increased to a more balanced ratio needed by crops. The present invention produces a phosphorus fertilizer material that is greater than about 10% P₂O₅. Furthermore, this phosphorus product is only about 15% of the initial volume of the poultry litter.

In addition, the remaining washed solid residue has a more balanced nitrogen to phosphorus ratio that is environmentally safe for land application and use by crops. As an alternative, washed litter residue can be digested for methane production of utilized as bedding especially in areas where bedding material is in short supply.

Poultry litter used in the following experiments consisted of wood chip bedding plus manure accumulated during bird production. Broiler litter for Examples 1 and 2 below was collected from a 27,400-bird broiler house in Sumter County, South Carolina. At the time of sampling, the litter was being used by the fifth consecutive flock (approximately 6.5 flocks per year). Two composite litter samples were taken in approximately two 12-meter transects covering the width of the house. Composite samples were placed in 20-liter plastic sealed containers and stored in the freezer until preparation for laboratory experiments.

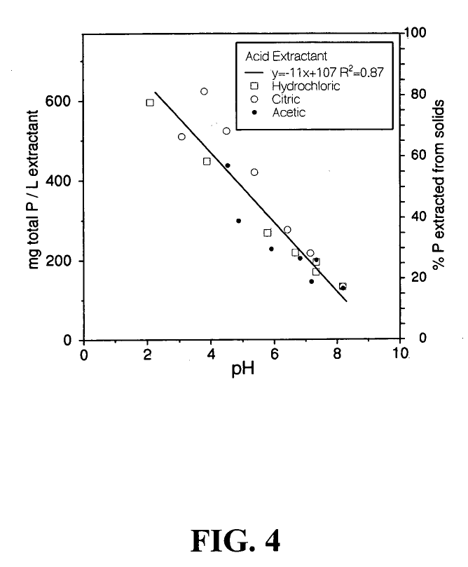

Broiler litter used for field prototype experiments was collected from a 25,000-bird broiler house. At the time of sampling, the house was empty and between the second and third flock (5 flocks per year). Two large composite litter samples were taken in two transects along the house, in its center section between water lines, and placed in 160-L containers. The containers were sealed, transported and placed in cold storage of about <2 degrees centigrade. Two 15.2 kg samples were prepared for field prototype experiments. In average, the two samples contained approximately 28.6 (±0.6)% moisture, approximately 26.2 (±0.04) mg/kg TKN, and approximately 15.5 (±3.8) mg/kg total phosphorus (Table 1 below). Prior to field prototype tests, broiler litter was ground and homogenized using a chipper (Yard Machines 5 HP model, MTD LLC, Cleveland, Ohio). Average particle size distribution of chipped poultry litter is shown in FIG. 4.

Analysis of supernatant liquid was performed according to Standard Methods for the Examination of Water and Wastewater (APHA, 1998). Total phosphorus and Total K nitrogen were determined in liquid and solid samples using the automated ascorbic acid method (Standard Method 4500-P F) and the phenate method (Standard Method 4500-NH₃ G) adapted to digested extracts (Technicon Instruments Corp., 1977), respectively. Total nitrogen is the sum of total K nitrogen plus nitrate-nitrogen. Nitrate nitrogen was also determined using Standard Method 4500-NO₃⁻F; it represented less than about 3% of total nitrogen. The pH of the supernatant liquid was measured electrometrically using a combination pH electrode. Total suspended solids (TSS) were determined by retaining solids on a glass-fiber filter (Whatman grade 934AH, Whatman Inc.; Clifton, N.J.) dried to approximately 105 degrees centrigrade (Standard Method 2540 D). Moisture in solids was determined using a microwave moisture analyzer (Omnimark Instrument Corp., Tempe, Ariz.). Elemental analysis of recovered phosphorus-rich solids for total carbon and nitrogen was done by dry combustion (Leco Corp., St. Joseph, Mich.) and for phosphorus, calcium, magnesium, potassium, and sodium by inductively coupled plasma (ICP) from nitric acid plus H₂O₂ digested extract (Peters et al., 2003).

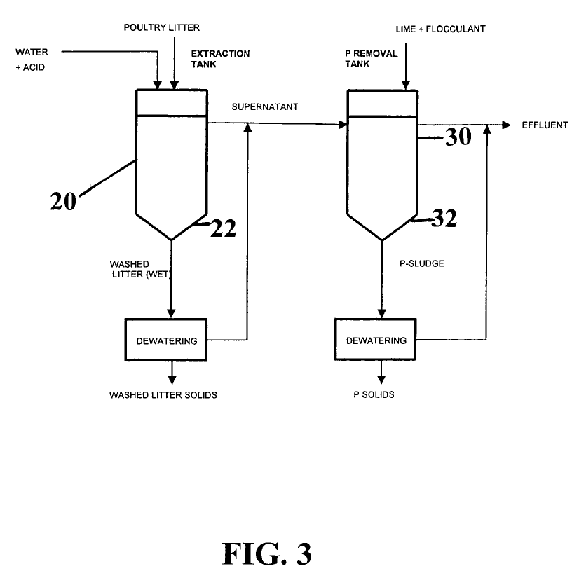

The process can be carried out in batch mode using a single vessel to do the mixing and settling in step 1 or steps 2 and 3 (FIG. 2) or adapted for continuous operation using two separate vessels to do the mixing first and then the settling (FIG. 3).

The following examples are intended only to further illustrate the invention and are not intended to limit the scope of the invention as defined by the claims. Poultry litter is used as a model for solid animal or poultry manure to demonstrate the invention.

### EXAMPLE 1

Organic and inorganic acids were tested for their potential to extract phosphorus in from poultry litter. Poultry litter samples were prepared by grinding and passing through a sieve of about 5.8 mm. Aqueous solutions of acetic, citric, and hydrochloric acids were added to about 2.00 grams of ground and sieved poultry litter samples in a ratio of about 1:2.5 w/v at concentration levels of about 0,2.5,5, 10, 20, 40, and 80 mmoles/liter. The solutions and litter were mixed in a reciprocating shaker at about 135 oscillations/minute at ambient temperature of about 23° C. for approximately 1 hour. Subsequently solids and liquid were separated by centrifuge at about 2000×g for about 5 minutes. The liquid supernatant was decanted and analyzed for pH, total phosphorus (TP), and total Kjeldahl nitrogen (TKN). Solids were air dried at about 40° C. and analyzed for total Kjeldahl and total phosphorus. The experiment was repeated and the treatment control consisted of extraction with distilled water. Treatment efficiency of the various acid treatments was established by comparison of phosphorus extraction relative to initial phosphorus content in untreated poultry litter (Technicon Instruments Corp., 1977), respectively. The ground and sieved poultry litter contained approximately 17.1±0.2% moisture, approximately 35.10±0.02 mg/kg of total kjeldahl nitrogen, and approximately 19.2±0.2 mg/kg total phosphorus (Table 1).

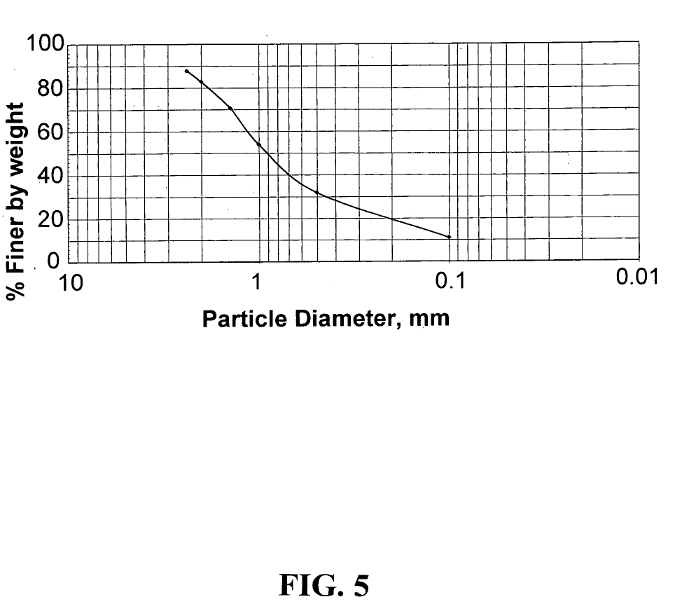

Both mineral and organic acids extracted phosphorus from poultry litter (FIG. 5). During extractions a significant portion of total phosphorus in poultry litter was released from the manure solids. Total phosphorus extraction rates increased with increasing acid concentrations. At approximately 40 mmol/L concentration of acid, about 81% of the initial total phosphorus content in broiler litter was extracted. In contrast, the distilled water (control) extracted only about 20%. In addition to the concentration of acid, the type of acid made a difference. Citric acid was more efficient at extracting phosphorus than HCl or acetic acid at similar molar applications (approximately 2.5 to 40 mmol/L). High extraction efficiencies (>70%) were also possible with HCl, but required molar rates that were double (approximately 80 mmol/L).

Even though phosphorus extraction increased from approximately 17% to approximately 81% with increased citric acid treatment in the range of approximately 0 to approximately 40 mmol/L, nitrogen extraction was not greatly affected (Table 2). Nitrogen contained in litter was extracted much less efficiently than phosphorus. For instance, about 81% of initial total phosphorus in litter was extracted in treatment 5 at about pH 3.8 (approximately 40 mM citric acid) but only about 27% of nitrogen was extracted (Table 2). Thus, the litter wash residue resulted in a nitrogen:phosphorus ratio of approximately 9.8. This is about 5-fold higher than the nitrogen:phosphorus ratio of the untreated litter (nitrogen:phosphorus ratio of about 2.1). Furthermore, this is in the range of nitrogen:phosphorus ratio required for balanced fertilization of crops for both nitrogen and phosphorus.

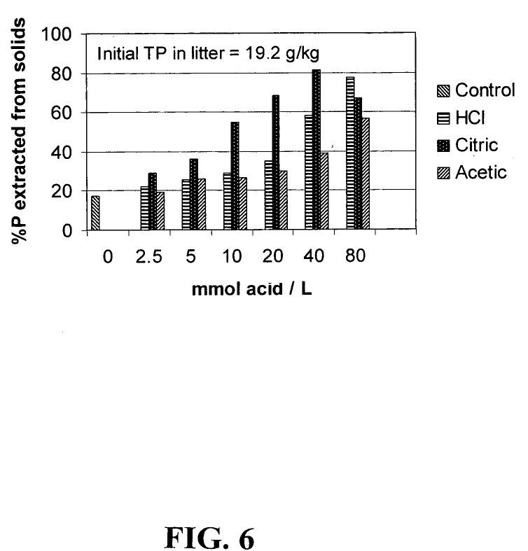

The percentage of phosphorus extracted from solids increased linearly with decreasing pH (y=−11x+107, R²=0.87, n=19, P<0.0001, FIG. 6). Although the quick wash process consistently extracted more than about 50% of total phosphorus when the pH of the acid solution-broiler litter mixture was lower than 5 units, similar percentages of phosphorus from broiler litter were extracted at different acid concentrations (FIG. 5). Thus, the amount of acid added in the process to extract a specific amount of phosphorus can be controlled by setting specific end point pH using a pH controller.

Although other mineral and organic acids can be used for the present invention, such as for example, sulfuric, malic, oxalic, phosphoric, nitric ethyldiamintetracetic, etc., the preferred acids are those that do not add phosphorus or nitrogen during the process of extracting phosphorus. Therefore, the use of acids such as phosphoric nitric, or ethyldiamintetracetic is not recommended.

The treated litter (washed solids) left at the end of the process can now be used for land application at rates based oh the nitrogen crop requirements without accumulation of excess phosphorus in the soil. Using data from Edwards and Daniel (1992), a nitrogen:phosphorus ratio of 5.2:1 would be needed to match Kentucky bluegrass specific nutrient uptake needs, which can be delivered with a phosphorus extraction at pH 4.5 (nitrogen:phosphorus=5.5). Higher nitrogen:phosphorus ratios needed for cotton (6.2:1), corn (7.5:1) or wheat (10.7:1) can be obtained at pH<4.5 (Table 2).

TABLE 1
Broiler litter characteristics.

| | | Total | | |
|---|---|---|---|---|
| | | Phosphorus | Total Nitrogen | Nitrogen:Phosphorus |
| Experiment | Moisture % | Mg/kg | Mg/kg | Ratio |
| Examples 1 and 2 | 17.6 | 19.4 | 34.6 | 1.8 |
| Sample 1 | | | | |
| Examples 1 and 2 | 16.6 | 19.1 | 35.5 | 1.9 |
| Sample 2 | | | | |
| Mean | 17.1 (0.2) | 19.2 (0.2) | 35.1 (0.02) | 1.9 |
| Field Prototype | 29.3 | 12.8 | 25.9 | 2.0 |
| Sample 1(Run 1) | | | | |
| Field Prototype | 27.9 | 18.2 | 25.9 | 2.0 |
| Sample 2 (Run 2) | | | | |
| Mean | 28.6 (0.6) | 15.2 (3.8) | 26.2 (0.04) | 1.7 |

TABLE 2
Effect of Citric Acid treatment on pH of the extraction solution-solids mixture,
total phosphorus and nitrogen extracted, and nitrogen:phosphorus ratio
in solid residue left after washing poultry litter.

| | | | Total | | | | |
|---|---|---|---|---|---|---|---|
| | | | Phosphorus | | Total Nitrogen | | Nitrogen:phosphorus |
| | pH | Acid | Extracted | | Extracted | | Ratio in Washed |
| Treatment | mixture | Mmol/L | g/kg litter | % | g/kg litter | % | Litter |
| 0 | 8.2 | 0.0 | 3.3 | 17 | 10.2 | 29.1 | 1.2 |
| 1 | 7.1 | 2.5 | 5.5 | 29 | 11.6 | 33.1 | 1.3 |
| 2 | 6.4 | 5 | 6.9 | 36 | 11.1 | 31.7 | 1.4 |
| 3 | 5.4 | 10 | 11 | 55 | 11.4 | 32.5 | 2.5 |
| 4 | 4.5 | 20 | 13 | 68 | 9.6 | 27.4 | 5.5 |
| 5 | 3.8 | 40 | 16 | 81 | 9.4 | 26.8 | 9.8 |
| 6 | 3.1 | 80 | 13 | 67 | 7.7 | 22.0 | 11.1 |

### EXAMPLE 2

To demonstrate the removal and recovery of phosphorus from the liquid extract, which includes steps 2 and 3 of the process, generated by litter washing (step 1) (FIG. 2), approximately 64 grams of poultry litter, as prepared in Example 1, was mixed with approximately 1.6 liters of 20 mM citric acid solution in a ratio of 1.25 w/v and stirred for about one hour with a magnetic stirrer. After the mixture settled for about 20 minutes, the liquid extract was separated from washed litter by decantation and transferred to separate laboratory vessels. To one half of the vessels, hydrated lime (Ca(OH)₂) was added, to the other half, lime and flocculant was added. Hydrated lime in water was added in various amounts until the pH of the mixed liquid reached set points of approximately 6, 7, 8, 9, 10, or 11 units (Treatments 1-6, respectively); a control treatment with no lime addition was included (Treatments). The recovery of phosphorus was enhanced by adding an organic flocculant to clump the fine particles of the phosphorus precipitate (Step 3). The organic flocculant was an anionic polymer (polyacrylaminde) Magnafloc 120 L with an approximately 34% mole charge and approximately 50% active ingredient (CIBA Specialty Chemicals Water Treatment, Inc., Suffolk, Va.). This flocculant was added at a rate of approximately 7.0 mg/L (active ingredient). For both lime only and lime plus flocculant addition, the liquid supernatant was decanted and analyzed for ph, total phosphorus, and total Khejdahl nitrogen. Solids were air dried at about 40° C. and analyzed for total Khejdahl nitrogen. Treatment efficiency of the various lime and flocculant treatments was expressed as percentage of phosphorus extraction relative to initial phosphorus content. All tests were conducted in duplicate.

A 20 mmol/L citric acid extract solution was selected for step 1 to further recovery of phosphorus with hydrated lime. This liquid extract contained a high total phosphorus concentration of about 600 mg/L at about pH 4.7 (Table 3, Treatment 0) and low total suspended solids (approximately 2.1 g/L) after liquid-solid separation, by decantation. In step 2, total phosphorus was removed from solution by precipitating soluble phosphorus compounds under alkaline conditions. Addition of hydrated lime decreased total phosphorus until a pH of approximately 8.0 units was obtained (Table 3).

Subsequent addition of a flocculant improved the percentage of total phosphorus removed at pH higher than 8.0 (Table 4). A small amount of an organic flocculant was added at a rate of about 7 mg/L (active ingredient) to all treatments to enhance thickening and phosphorus grade of the precipitated product (Step 3). Results in Table 4 show an increase of the amount of phosphorus extracted and higher phosphorus grade of the precipitate by addition of hydrated lime followed by flocculant enhancement. The highest phosphorus recovery rate and grade in the precipitate (about 18.8% P₂O₅) was obtained when the pH reached a value of about 10.0 units.

The enhancing effect of organic flocculant addition on total phosphorus content of the precipitate is summarized in Table 5 at three hydrated lime levels (pH approximately 8, 9, and 10) with and without application of polymer after citric acid (approximately 20-mM) extraction. From these results, more than 65% of total phosphorus in poultry litter can be recovered by the addition of hydrated lime and small amounts of organic flocculant (Steps 2 and 3).

TABLE 3
Quick wash process (Step 2), hydrated lime application for recovery
of extracted soluble phosphorus from broiler litter. Data show total
phosphorus concentration in liquid extract and corresponding
percentage of total phosphorus removed by increasing pH with
hydrated lime after phosphorus extraction (Step 1) with citric
acid solution (1:25).

| | | Ca(OH)₂ | | Total phosphorus |
|---|---|---|---|---|
| | | applied | Total phosphorus | removed from |
| Treatment⁽¹⁾ | pH | g/L liquid | mg/L | liquid extract % |
| 0 | 4.7 | 0.0 | 613 | 0 |
| 1 | 6.0 | 1.4 | 381 | 39 |
| 2 | 7.0 | 2.0 | 299 | 51 |
| 3 | 8.0 | 2.6 | 215 | 65 |
| 4 | 9.0 | 3.1 | 251 | 59 |
| 5 | 10.0 | 3.7 | 303 | 51 |
| 6 | 11.0 | 4.1 | 236 | 62 |

TABLE 4
Quick wash process (Steps 2 and 3), hydrated lime and flocculant
application for recovery of extracted soluble phosphorus from
broiler litter. Data show total phosphorus recovered per unit
weight of broiler litter and phosphorus grade of the
recovered phosphorus. Step 1 (P extraction), was
carried out using citric acid solution (1:25 w/v).

| | | Ca(OH)₂ | | | | Phosphorus |
|---|---|---|---|---|---|---|
| | | applied | | Total phosphorus | | grade in |
| | | | g/kg | recovered | | precipitate |
| Treatment⁽¹⁾ | pH | g/L liquid | litter | g/kg litter | % | % P₂O₅ |
| 0 | 4.7 | 0.0⁽³⁾ | 0.0 | 0.5 | 2.8 | 1.4 |
| 1 | 6.0 | 1.4 | 36 | 6.5 | 33.6 | 14.9 |
| 2 | 7.0 | 2.0 | 50 | 8.1 | 42.3 | 11.9 |
| 3 | 8.0 | 2.6 | 65 | 11.7 | 61.0 | 17.6 |
| 4 | 9.0 | 3.1 | 78 | 13.0 | 67.5 | 17.2 |
| 5 | 10.0 | 3.7 | 93 | 13.9 | 72.5 | 18.8 |
| 6 | 11.0 | 4.1 | 104 | 13.5 | 70.4 | 14.4 |

TABLE 5
Increased total phosphorus recovery in the quick wash process using
anionic polyacrylamide polymer application. Results are compared to
total phosphorus recovered without poly mer addition. For lime treatment,
refer to table 4.

| | | Total P Recovered^{[2]} | | |
|---|---|---|---|---|
| | | Without | | Recovery Increase |
| Lime | | polymer | With polymer^{[3]} | with Polymer^{[4]} |
| Treatment | pH^{[1]} | g/kg litter | | % |
| 3 | 8 | 10.0^{[4]} | 11.7 | 14.0 |
| 4 | 9 | 9.1 | 13.0 | 30.0 |
| 5 | 10 | 7.7 | 13.9 | 45.0 |

^{[1]}Specific pH values obtained using hydrated lime (2% Ca(OH)₂ in water).
^{[2]}Total P recovered = P removal from liquid fraction relative to initial P content in litter (19.2 g/kg).
^{[3]}Anionic polycrylamide, 37% charge, applied at a constant rate (7 mg/L active ingredient).
^{[4]}Data are the average of two replicates.

### EXAMPLE 3

A field prototype system was developed to evaluate the process, of the present invention to extract and recover phosphorus from poultry litter. The system included two connected reactor vessels (FIG. 3). The extraction vessel 20 in the sequence was the phosphorus extraction reactor that consisted of an approximately 378-liter tank with a conical bottom 22, a mixer 24, and a pH controller (not shown). Once liquid reacted with solids, stirring was stopped to let solids settle. After settling of solids, the supernatant from tank 20 was pumped to a second vessel, a phosphorus removal tank 30. The tank 30 in the sequence was the phosphorus recovery reactor that consisted of a second about 378 liter tank with a conical bottom 32, mixer (not shown).and pH controller (not shown). The unit was completed with a smaller 115 gallon tank (not shown) with a mixer and pump used to stir and inject the hydrated lime solution into the tank 30. Solid and liquid sampling was done in duplicate. Phosphorus extraction was performed by adding citric acid, approximately 10% w/w to a stirred mixture of approximately 15.2 kg of broiler litter, prepared as in Example 1, and water in a ratio of approximately 1:25 w/v inside the extraction reactor 20. Addition of citric acid stopped when the pH of the mixture reached a set point of approximately 4.5. The extraction mixture was sampled about every 10 minutes during about a sixty minute stirring period to determine the minimum stirring time required to reach a stable total phosphorus concentration in the extraction liquid; total phosphorus was determined in supernatant after about a 24 hour setting of unfiltered samples. The treated litter solids were removed from the bottom of the phosphorus extraction tank 20 after about a twenty minute settling period and further dewatered through a filter. The filter was a 0.84 m×0.84 m×0.13 sieve box with a 0.6 wire mesh bottom and a commercial polypropylene non-woven fabric (Dupont E.I. de Nemours, N.J.).

The supernatant from the phosphorus reactor was pumped into the phosphorus recovery reactor tank 30 and hydrated lime, about 10% Ca(OH)₂, was injected and mixed. pH controller (not shown) stopped the; lime injection when the pH of the mixed liquid reached a set point of about 9.0 in the first experiment or about 10 in the second experiment. Once the desired pH was reached, about 15 mg/L of anionic polyacrylamide, a flocculant, was injected and mixed to enhance phosphorus recovery. The precipitated solids were removed from the bottom of the tank after an approximately 30 minute settling period and dewatered through a filter as described above. The dried P-solids were analyzed for phosphorus, carbon, nitrogen, calcium, magnesium, potassium, and sodium content.

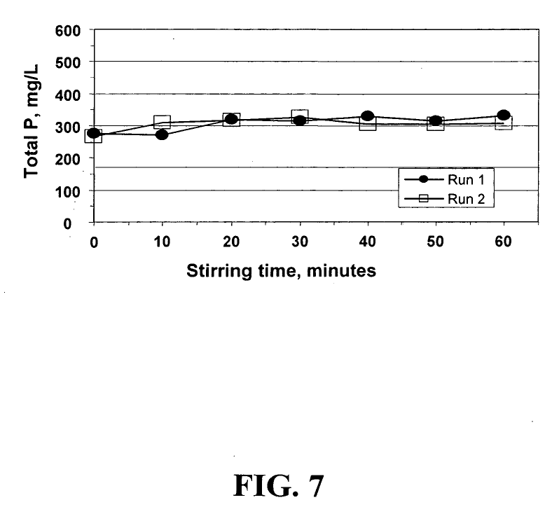

The prototype experiment was based on the acid and alkaline endpoint pH values that were determined in Examples 1 and 2 to extract and recover more than about 65% of total phosphorus from poultry litter. This procedure avoided an excessive, chemical application. Consequently, in the prototype experiment, phosphorus was extracted from broiler litter using citric acid solution at approximately pH 4.5. The first tested component was the effect of stirring time on amount of phosphorus extracted from the slurry formed by mixing litter and extracting liquid (Step 1). Extracted total phosphorus concentration remained stable (approximately 300-330 mg/L) at pH of approximately 4.5 with stirring time of about 20 minutes or more (FIG. 7). From these results, it was confirmed that stirring time of about 20-60 minutes is sufficient to obtain a stable total phosphorus extracted concentration during extraction process at a pH of approximately less than 5.0.

Phosphorus extraction performance of the prototype system under field conditions (Table 6) was consistent with performance obtained in the laboratory (FIGS. 5 and 6). Phosphorus extraction efficiencies of approximately 65 to approximately 75% with respect to initial total phosphorus in broiler litter were obtained with pH treatment of approximately 4.5 for both runs. As a result of phosphorus extraction, the average nitrogen:phosphorus ratio is better for crop utilization. As an alternative, the dried washed litter could be reused in the broiler house as bedding in geographic areas where bedding materials are in short supply or digested for methane production.

After settling in the phosphorus extraction tank, the supernatant liquid had a low total suspended solids (TSS) concentration of approximately <3.5 g/L, with respect to the total suspended solids concentration of the extraction slurry of approximately 28.7 g/L. This clarified liquid was pumped to the phosphorus recovery tank reactor and treated with hydrated lime and flocculant. This treatment recovered approximately 92 to 89% of phosphorus extracted in step 1. The complete process recovered >60% of the initial total phosphorus in broiler litter; higher phosphorus recovery rates were obtained at a pH of approximately 10.0 (Table 6).

Before dewatering, mean initial moisture of the phosphorus sludge was about 96.3% (Table 7). After filtration, the sludge had a mean moisture content of about 88.8%. The drying process was further accelerated by placing the phosphorus sludge in a greenhouse. The mean moisture content declined to about <10% in the subsequent thirteen days after filtration.

The prototype performance confirmed laboratory results that about >60% of the total phosphorus content of poultry litter can be recovered using the quick wash method of the present invention (Table 6). The phosphorus grade of the product obtained in the prototype was lower (about 11.1% P₂O₅=4.85 mg P/100 grams×2.29) than the precipitate obtained in the laboratory (Tables 3 and 8). For example, on a dry matter basis, litter treated in the prototype had a lower mass and lower phosphorus concentration per volume of extracting solution.

In average, the precipitate contained relatively large amounts of phosphorus, carbon (C), nitrogen (N), and calcium (Ca), and small amounts of magnesium (Mg), potassium (K), and sodium (Na) (Table 8). Thus, the resulting molar ratio was about 1:7:1.6:1.4 for P:C:N:Ca.

An additional characteristic of the recovered phosphorus product was its reduced bulk volume. The recovered phosphorus product (average dry bulk density of about 780 g/dm³) had about 17% of the initial volume of poultry litter. Therefore, the recovered phosphorus product can be transported mote economically off me farm for use as a fertilizer material.

TABLE 6
Performance of field prototype to remove phosphorus from
poultry litter using the quick wash process.

| Litter Before Wash | | | | Extraction | | | Recovery | | |
|---|---|---|---|---|---|---|---|---|---|
| | Total | | N:P | | Total | | | Total | |
| | P | | Ratio | | P^{[2]} | | | P^{[3]} | |
| | g/kg | N:P | Washed | | g/kg | | | g/kg | |
| Run | litter | Ratio^{[1]} | Litter | pH | litter | % | pH | litter | % |
| 1 | 12.8 | 2.0 | 4.4 | 4.5 | 8.3 | 65 | 9.0 | 7.7 | 60 |
| 2 | 18.2 | 1.5 | 4.1 | 4.5 | 13.7 | 75 | 10.0 | 12.2 | 67 |
| Aver- | 15.5 | 1.75 | 4.3 | 4.5 | 11 | 70 | 9.5 | 10.0 | 64 |
| age | | | | | | | | | |

^{[1]}Initial N content in litter: 2.59 and 2.65 g/kg for run 1 and 2, respectively.
^{[2]}Total P extracted = P extracted relative to initial P content in litter before wash.
^{[3]}Total P recovered = P recovered in precipitated solids relative to initial P content in litter after flocculant application.

TABLE 7
Percent moisture of phosphorus sludge before and after dewatering.

| | Percent Moisture | | |
|---|---|---|---|
| Sludge Phosphorus | g per 100 g | | |
| Dewatering | Run 1 | Run 2 | Mean |
| Initial Moisture^{[1]} | 96.0 | 96.5 | 96.3 |
| After Filtering^{[2]} | 89.0 | 88.6 | 88.8 |
| Air Dried^{[3]} | 10.1 | 9.1 | 9.6 |

^{[1]}Sludge obtained after decantation of liquid after flocculant addition (step 3)
^{[2]}Dewatering for 24 hours after filtration through polypropylene non-woven filter fabric.
^{[3]}Air dried for 13 days after dewatering in greenhouse, average temperature = 37 degrees C. and relative humidity = 54%.

TABLE 8
Percent elemental composition of the solid precipitate produced
from poultry litter using the quick wash process^{[1]}.

| | Percent Composition | | |
|---|---|---|---|
| | g per 100 g | | |
| Constituent | Run 1 | Run 2 | Mean |
| Phosphorus | 4.61 | 4.79 | 4.70 (0.13) |
| P₂O₅^{[2]} | 11.16 | 10.95 | 11.06 (0.15) |
| Carbon | 35.60 | 36.11 | 35.90 (0.36) |
| Nitrogen | 3.61 | 3.47 | 3.54 ((0.10) |
| Calcium | 11.89 | 10.54 | 11.22 (0.95) |
| Magnesium | 0.70 | 0.68 | 0.69 (0.01) |
| Potassium | 0.90 | 0.97 | 0.94 (0.05) |
| Sodium | 0.29 | 0.33 | 0.31 (0.03) |

^{[1]}Data for Run 1 and Run 2 obtained at about pH 9 and 10, respectively (Table 6) expressed as oven dry values.
^{[2]}Phosphorus grade expressed as P₂O₅₌% P × 2.29

### EXAMPLE 4

This demonstrate that the manure wash treatment is also effective to remove P from other animal manure besides poultry litter. A 64-g hog manure sample was mixed with about 1.6 L of 10-mM citric acid solution and stirred for approximately one hour. Similar to Examples 1 and 2 above, after the manure-liquid extract mixture settled for about 20 minutes, the liquid extract was separated from the washed litter by decantation and transferred to separate laboratory vessels. Hydrated lime was added to the vessels in various amounts until the pH of the mixed liquid reached set points of about 6, 7, 8, 9, 10 and 11 units (Treatments 1-6, respectively); the test included a control (treatment 0) with no lime addition. The recovery of P was enhanced (step 3) by adding the same flocculant as in experiment 2 (7.0 mg L⁻¹ active ingredient) to all six lime treatments and control. Liquid supernatant was decanted and analyzed for pH, TP, and TKN; solids were air dried at 40° C. and analyzed for TKN and TP. The tests were conducted in duplicate.

Table 9 shows experimental data supporting that the quick wash process can be used for swine manure treatment and other fresh animal manures. In step 1, phosphorus from fresh manure was extracted at pH 4.5 when mixed with 10-mM citric acid (Table 9, treatment 0). Results in Table 9 show an increase of the amount of phosphorus, recovered by addition of hydrated lime (step 2) and organic flocculant (step 3). The highest phosphorus recovery-rate (6.4 g/kg manure) was obtained when the pH reached a value between 9.0 and 10.0 units. Thus, about 90% of total phosphorus in swine manure can be recovered by the addition of hydrated lime and small amount of organic flocculant. From this example, we concluded that the quick wash treatment can be used for P extraction and recovery from animal manures other than poultry litter.

TABLE 9
Quick wash process (steps 2 and 3), hydrated lime and flocculant
application for recovery of phosphorus from swine manure after
phosphorus extraction (step 1) with citric acid solution. Data show
phosphorus recovered fresh swine manure by incresing pH with
hydrated lime and organic flocculant addition.

Total P Recovered

| Lime Treatment | pH^{[1]} | g/kg manure | % |
|---|---|---|---|
| 0 | 4.5 | 0.0 | 0 |
| 1 | 6.0 | 2.2 | 31 |
| 2 | 7.0 | 4.7 | 66 |
| 3 | 8.0 | 6.2 | 87 |
| 4 | 9.0 | 6.4 | 90 |
| 5 | 10.0 | 6.4 | 90 |
| 6 | 11.0 | 6.3 | 89 |

^{[1]}Specific pH treatment was obtained by addition of hydrated lime (2% Ca(OH)₂ in water). An anionic polymer (polyacrylamide) was added at a rate of 7 mg/L (active ingredient) to all treatments to enhance precipitation.
^{[2]}% Total P recovered = P recovered relative to initial P content in fresh swine manure (7.1 g/kg). Solids content of fresh manure = 30%.
^{[3]}Data are the average of two replicates.

Those skilled in the art will recognize that this invention may be embodied in other species than illustrated without departing from the spirit and scope of the essentials of this invention. The foregoing discussion is therefore to be considered illustrative and not restrictive. The scope of the invention is only limited by the appended claims.

1. A process for recovering phosphorus from solid animal wastes comprising:
a. a phosphorus extraction step,
b. a phosphorus removal step, and
c. a phosphorus recovery enhancement step,
wherein said process removes greater than about 60% of total phosphorus.

2. The process of claim 1 wherein said extraction step includes a rapid hydrolysis reaction.

3. The process of claim 2 where said hydrolysis step is performed at pH of about less than 5.

4. The process of claim 2 wherein said hydrolysis reaction uses acid selected from the group consisting of a mineral acid, an organic acid, or mixtures thereof and their precursors.

5. The process of claim 1 wherein a washed litter residue and a liquid extract are separated after the phosphorus extraction step.

6. The process of claim 5 wherein said washed litter extract is dewatered.

7. The process of claim 1 wherein said phosphorus removal step includes precipitating phosphorus by the addition of an alkaline base to a liquid extract produced in said extraction step to produce an alkaline earth metal-containing phosphorus.

8. The process of claim 4 wherein said step of enhanced phosphorus recovery includes adding a flocculant to said liquid extract.

9. A fertilizer material produced by the process of claim 1.

10. A bedding material produced by the process of claim 1.

11. A bedding material produced by the process of claim 4.

12. A bedding material produced by the process of claim 5.

13. A bedding material produced by the process of claim 6.

14. A bedding material produced by the process of claim 7.

15. A washed litter residue produced by the method of claim 1.

16. A washed litter residue produced by the method of claim 4.

17. A washed litter residue produced by the method of claim 5.

18. A washed litter residue produced by the method of claim 6.

19. The process of claim 5 further comprising digesting said washed litter in a process for methane production.

20. The process of claim 6 further comprising digesting said washed litter in a process for methane production.
